(19) United States
(12) Patent Application Publication
(10) Pub. No.: US 2014/0256420 A1
(43) Pub. Date: Sep. 11, 2014

(54) UNIVIED GAME PREVIEW

(71) Applicant: MICROSOFT CORPORATION, Redmond, WA (US)

(72) Inventors: John Raymond Justice, Bellevue, WA (US); Krassimir Emilov Karamfilov, Bellevue, WA (US); Frank R. Morrison, III, Kirkland, WA (US)

(73) Assignee: MICROSOFT CORPORATION, Redmond, WA (US)

(21) Appl. No.: 13/792,915

(22) Filed: Mar. 11, 2013

(51) Int. Cl. G06F 12/00

(52) U.S. Cl. CPC G06F 12/00
USPC 463/29

(57) ABSTRACT

Embodiments of the present invention provide a video game preview. The video game preview may run on a game client or on a game server associated with a game service. A current preview experience is maintained by causing the client or server to access a central preview file that defines the preview experience. The preview may be provided by the game service or on the game client depending on circumstances. In one embodiment, if game code for the preview is present locally on the client, then the client provides the preview. If the video game code is not available locally at the game client, then the preview is either generated by the game service and streamed to the game client or the code is downloaded to the game client to enable the client to generate the preview.

### BACKGROUND

Before purchasing a full version of the game, a player may wish to preview the game. A person may be able to preview a game by going to a store and playing the game or a limited version of the game. Game developers may create an entirely separate preview experience by writing game code that is not part of the regular game. For example, a preview might be a special level that is not part of actual game play. This separate preview experience may be given to players via download.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention provide a video game preview. The video game preview may run on a game client or on a game server associated with a game service. Either way, the user receives a similar preview experience that is up to date. A current preview experience is maintained by causing the client or server to access a central preview file that defines the preview experience. The preview file is separate from the game code that enables game functionality. The same game code may be used to create a full version of the game and a preview version of the game.

As mentioned, the preview may be provided by the game service or on the game client depending on circumstances. In one embodiment, the preview process starts by determining where the preview should run. If game code for the preview is present locally on the client, then the preview file is downloaded, or accessed, from the game service and used to provide a preview. If the video game code is not available locally at the game client, then the preview is either generated by the game service and streamed to the game client or the code is communicated to the game client to enable the client to generate the preview. The preview is generated by the game service when the quality of the network connection between the game service and game client meets a designated threshold.

In addition to running on either a game client or game server, the preview allows the user to save progress for achievements accumulated during the preview. When a user purchases the full version of the game, the user may be able to keep progress and pick up from where the user left off. In one embodiment, the user is only able to keep their achievements when they purchase the game.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of an online gaming environment, in accordance with an embodiment of the present invention;

FIG. 3 is a diagram of a game preview environment, in accordance with an embodiment of the present invention;

FIG. 4 is a diagram illustrating three different preview scenarios within a game preview environment, in accordance with an embodiment of the present invention;

FIG. 5 is a sequence diagram showing communications within a gaming environment that facilitate the migration of game play from a gaming server to a gaming client, in accordance with an embodiment of the present invention;

FIG. 6 is a sequence diagram showing communications occurring within a gaming environment during migration of a game from a client gaming device to a server-located gaming service, in accordance with an embodiment of the present invention;

FIG. 7 is a flow chart showing a method of providing a video game preview, in accordance with an embodiment of the present invention;

FIG. 8 is a flow chart showing a method of providing a video game preview, in accordance with an embodiment of the present invention; and

FIG. 9 is a flow chart showing a method of providing a video game preview, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide a video game preview. The video game preview may run on a game client or on a game server associated with a game service. Either way, the user receives a similar preview experience that is up to date. A current preview experience is maintained by causing the client or server to access a central preview file that defines the preview experience.

The preview file is separate from the game code that enables game functionality. The same game code may be used to create a full version of the game and a preview version of the game. The device generating the preview uses the preview file to determine what parts of the full game are accessible during the preview. In one embodiment, the preview file includes a preview decryption key that only partially decrypts the full game code. Upon purchase, a full decryption key could be provided to allow instant access to the full game.

In one embodiment, a central data store maintains a collection of preview files for different game titles. The preview file is accessed in real time to generate a preview. Maintaining a central preview file for a video game title allows the preview file to be updated periodically. For example, if users are not responding positively to a preview that allows access to only one player, then the preview parameters could be changed to allow a multi-player preview scenario. Because the preview parameters are maintained by a game service, the same preview is provided on the game client or by a game server.

As mentioned, the preview may be provided by the game service or on the game client depending on circumstances. In one embodiment, the preview process starts by determining where the preview should run. As part of the determination, local memory or files available locally to the game client are evaluated to determine whether code capable of running the video game is present locally. If the game code is present locally, the preview is generated locally. To generate the preview locally, the preview file is downloaded from the central data store and used to provide a preview in combination with the local game code. The preview file may partially decrypt the game code.

If the video game code is not available locally at the game client, then the preview is either generated by the game service and streamed to the game client or the code is downloaded to the game client to enable the client to generate the preview. The preview is generated by the game service when the quality of the network connection between the game service and game client meets a designated threshold. Initially, the characteristics of the connection between the game client and the game server are evaluated. If the quality of service (“QOS”) is above a threshold, then the preview is streamed to the game client. The threshold may be established as a point where network QOS creates above a threshold amount of latency. In one embodiment, the threshold latency is 60 ms. The threshold latency could be different for each game. A game service or preview manager may store a record of the threshold latency that is acceptable for each game.

When the QOS is below the threshold, then the video game code is downloaded to the client. Once downloaded, the client accesses the preview file from the game service to decrypt part of the game needed to create the preview. The same code that is used to create the preview in combination with the decryption key may be used to run the full version of the game using a full decryption key. In this way, the same code can provide both the preview and the full game using different decryption keys.

In addition to running on either a game client or game server, the preview allows the user to save progress and earn achievements accumulated during the preview. When a user purchases the full version of the game, the user is able to keep their progress and pick up from where the user left off. In one embodiment, the user is only able to keep their achievements when they purchase the game.

Having briefly described an overview of embodiments of the invention, an exemplary operating environment suitable for use in implementing embodiments of the invention is described below.

### Exemplary Operating Environment

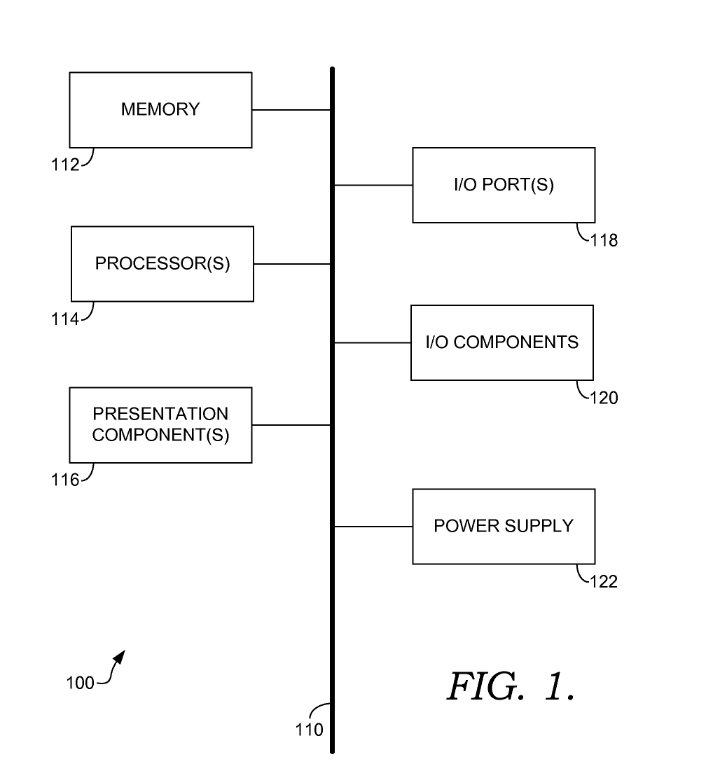

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Online Gaming Environment

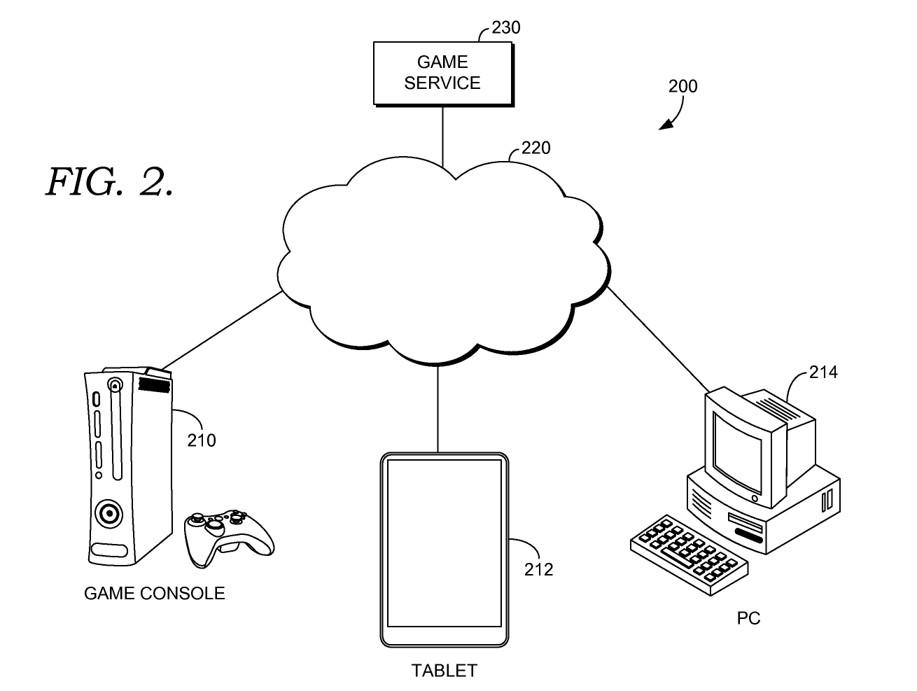

Turning now to FIG. 2, an online gaming environment 200 is shown, in accordance with an embodiment of the present invention. Game previews may be provided within the environment 200. The online gaming environment 200 comprises various game clients connected through a network 220 to a game service 230. Exemplary game clients include a game console 210, a tablet 212, and a personal computer 214. Use of other game clients, such as smart phones, are also possible. The game console 210 may have one or more game controllers communicatively coupled to it. In one embodiment, the tablet 212 may act as an input device for a game console 210 or a personal computer 214. In another embodiment, the tablet 212 is a stand-alone game client. Network 220 may be a wide area network, such as the Internet.

Game service 230 comprises multiple computing devices communicatively coupled to each other. In one embodiment, the game service 230 is implemented using one or more server farms. The server farms may be spread out across various geographic regions including cities throughout the world. In this scenario, the game clients may connect to the closest server farms. Embodiments of the present invention are not limited to this setup.

The game service 230 allows the game to be executed within the computing devices provided by the game service 230. A communication session between the game service and game clients carries input traffic to the game service 230 and returns a rendered game image. In this embodiment, a computing device that is part of the game service executes the video game code using a control stream generated by input devices associated with the various game clients. The rendered video game is then communicated over the network to the game client where the rendered game is output for display.

The game service may provide a preview in the same way. Control input is provided by the client, game code is executed by the server, and then a rendered game image is communicated to the client. The client may also generate a preview using a preview file, as will be explained.

### Exemplary Game Client and Game Service for Game Migration

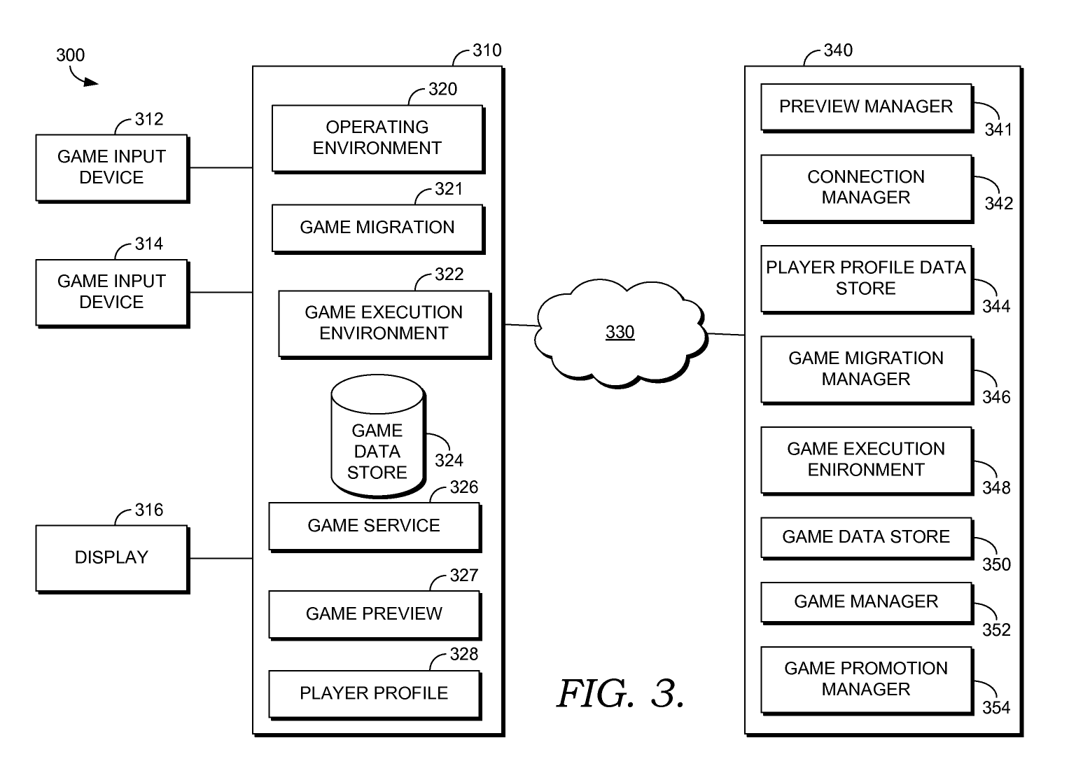

Turning now to FIG. 3, an exemplary game preview environment 300 is shown, in accordance with an embodiment of the present invention. The game preview environment 300 includes a game client 310 that is shown communicatively coupled to a game server 340 through a network 330. In one embodiment, the network may be the Internet. The game client 310 is connected to a first game input device 312, a second game input device 314, and a display 316. Exemplary game input devices include game pads, keyboards, a mouse, a touch pad, a touch screen, a microphone for receiving voice commands, a depth camera, a video camera, a keyboard, and a trackball. Embodiments of the present invention are not limited to these input devices. The display device 316 is capable of displaying video game content. For example, the display 316 may be a television or computer screen. In another embodiment, the display 316 is a touch screen integrated with the game client 310.

The game client 310 is a computing device that is able to execute video games. The game client 310 could be a tablet or a laptop computer. In another embodiment, the game client 310 is a game console and the display 316 is a remote display communicatively coupled to the game console. The game client 310 includes an operating environment 320, a game migration component 321, a game execution environment 322, a game data store 324, a game service client 326, a game preview component 327, and a player profile data store 328.

The operating environment 320 may be provided by an operating system that manages the hardware and provides services to application running on the game client 310. The operating environment may allocate client resources to different applications as part of the game migration. For example, the operating environment may give control of the display to the game execution environment 322 once game play is migrated to the game client 310.

The game migration component 321 manages game migration functions performed by the client 310. The game migration component 321 may initiate migration of game play from the client 310 to the game server 340. The game migration component 321 may also participate in migrating game play from the game server 340 to the client 310. The game migration component 321 may communicate with the game service running on the game server 340 to request migration of a game session to the game server 340. The request may include the particular game the request is associated with as well as the state of the current game if it is running within the game execution environment 322. Game play may be migrated in response to instructions received from the server or detection of a triggering event. The game migration component 321 may detect a triggering event.

Several trigger events are possible. There are several scenarios where reaching the end of a partially downloaded game is a trigger to move play to the server 340 until the next portion of the game is available for play on the client. In one scenario, the user downloads a first portion of the game in a block, such as a block that allows the user to play levels one through three. As a user approaches the end of level three, and the next block has not been downloaded, a triggering event may be recognized. The game migration would occur to allow user to play level four on the server when the end of level three is reached.

In another embodiment, a game-purchase event is a trigger. When the preview portion of the game runs out, without the rest of the game having first been downloaded, the game play may migrate from the game client 310 to the server 340 upon purchasing a full version of the game. In another scenario, even games that have been fully downloaded to the game console may have game experiences or levels that are only provided by the server. For example, a game may have a final level that is extremely large and only available on the server.

The game execution environment 322 comprises the gaming resources on the client 310 required to execute instances of a game or a game preview. The game execution environment 322 comprises active memory along with computing and video processing. The game execution environment 322 receives gaming controls and causes the game to be manipulated and progressed according to its programming. In one embodiment, the game execution environment 322 outputs a rendered video stream that is communicated to the display 316.

The game data store 324 stores downloaded games, game previews, and partially downloaded games. Games may be downloaded in playable blocks. For example, the first playable block could allow the player to play a first level. To play a game or a preview on the client 310, the game may need to be loaded from the game data store 324 into active memory associated with the game execution environment 322.

The game service client 326 is a client application that displays rendered video game images received from the game service running on server 340. The game service client 326 may also process game input and change it into an easily uploadable format that is communicated to the server 340. The game service client 326 may also scale the rendered video game images received from the server 340 to a size optimized for display 316.

The game preview component 327 facilitates client side functions related to a game preview. For example, the preview component 327 may retrieve the preview file from the preview manager 341. The preview component 327 may enforce digital rights management related to preview expiration.

The player profile data store 328 stores player profile information for individual games. The player profile information may also save tombstones or game-saved data for individual games, including previews. This player profile data or game progress data may be communicated back and forth as part of the game migration process and the game preview process. For example, when a game is migrated from the server 340 to the game client 310, a game-save file or tombstone may be communicated to the game client 310. Both the game-save file and the tombstone record game progress. The game execution environment 322 then reads the game-saved data to start the game where the player left off on the server. The opposite scenario is also possible where the game-saved data and player profile information is uploaded from the game client 310 to the server 340 when game play migrates from the client to the server.

The player-profile data store 328 may save game progress for game previews. This allows the user to continue a preview session where they left off. In addition, the progress may be applied to a full version of the game when purchases. Thus, a player may start with some player strengths or accomplishments from the time spent playing the preview. Some game services also allow players to earn points or achievements while playing the game. These points may go into an overall ranking for the player for the individual title or across multiple titles. In addition, the points may be used to receive discounts or provide access to certain features. In one embodiment, achievements are only given to a player upon purchasing the preview.

The game server 340 comprises a preview manager 341, a connection manager 342, a player profile data store 344, a game migration manager 346, a game execution environment 348, a game data store 350, a game manager 352, and a game promotion manager 354. Though depicted as a single box, the game server 340 could be a server farm that comprises numerous machines, or even several server farms.

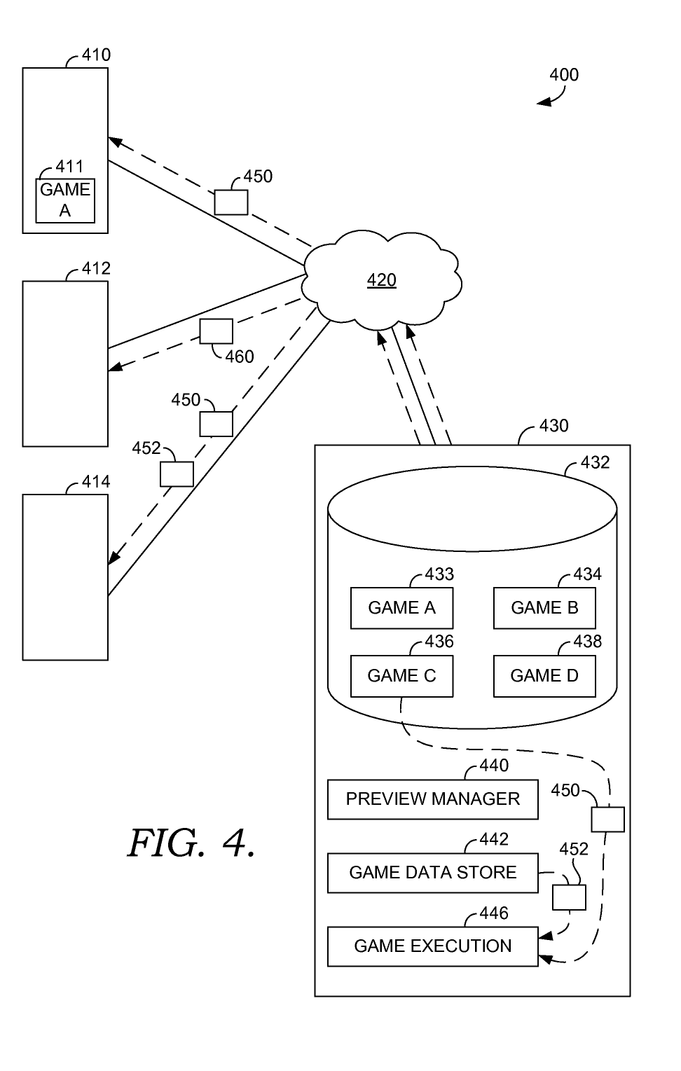

The preview manager 341 generates, stores, and distributes preview files that define a preview experience. The preview file may be distributed internally within the game server 340 or externally to a game client 310. In addition, the preview manager 341 may provide an interface that allows developers or others to generate or modify the preview file. Functions of a preview manager are described in more detail with reference to FIG. 4.

The connection manager 342 builds a connection between the client 310 and the server 340. The connection manager 342 may also provide various authentication mechanisms to make sure that the user is authorized to access the game service provided by the server 340. The connection manager 342 may also analyze the bandwidth available within a connection and throttle the download of a game during game play to make sure that game play is not degraded.

The player profile data store 344 may work in conjunction with the connection manager 342 to build and store player information. Part of the player profile may comprise demographic and financial information such as a player's name, address and credit card information or other mechanism for paying for or purchasing games and experiences provided by the game service.

In addition, the player profile data store 344 may store a player's progress within an individual game. As a player progresses through a game or game preview, the player's score and access to game levels may be stored. Further, the player profile data store 344 may store information about individual player preferences such as language preferences. Information regarding a player's game client and speed of the network connection may also be stored and utilized to optimize the gaming experience. For example, in one embodiment, when a geographically proximate server farm is busy, players with higher latency Internet connections may be preferentially connected to proximate server farms while players with lower latency connections may be connected to server farms that are further away. In this way, the players with the network connections that are best able to handle the additional latency are connected to server farms that create additional latency because of their location.

The player profile data store 344 may also store a usage history for the individual player. A player's history of purchasing games, sampling games, or playing games through a game service that does not require the purchase of the games may be stored. The usage information may be analyzed to suggest games of interest to an individual player. In one embodiment, the purchase history may include games that are not purchased through the game service. For example, the purchase history may be augmented by the player entering in a key from a game purchased in a retail store. In some embodiments, the player may then have access to that game both on their game client 310 and through the game service when they are no longer at their game client.

The game migration manager 346 manages the migration of game play from the server 340 to the client 310 and may help with the migration of game play from the client 310 to the server 340. As with game migration component 321, the game migration manager 346 may detect trigger events and initiate game migration in response. In addition to the triggering events mentioned previously, the successful download of a game block containing code for a game currently being played on the server 340 is a triggering event that may initiate game migration from the server 340 to the client 310. For example, the user may be previewing a first game that is running on the server. The game migration manager 346 (or other component) communicates to the client the block of data required to preview the first part of the game. Once this block of data is successfully downloaded, then an instruction may be sent to migrate the preview from the server 340 to the client 310. Once the game preview is successfully migrated, the bandwidth previously being used to play the game on the server may be dedicated to downloading the rest of the game preview to the client 310 or start downloading a different game.

The game execution environment 348 comprises the gaming resources required to execute instances of a game. These are the resources described previously that are managed by the game manager 352 and other components. The game execution environment 348 comprises active memory along with computing and video processing. The game execution environment 348 receives gaming controls through an I/O channel and causes the game to be manipulated and progressed according to its programming. In one embodiment, the game execution environment 348 outputs a rendered video stream that is communicated to the game client. In other embodiments, the game execution environment 348 outputs game geometry, or other representations, which may be combined with local objects on the gaming client to render the gaming video.

The game data store 350 stores available games. The games may be retrieved from the data store and activated through an active memory. The game data store 350 may be described as passive or secondary memory. In general, games may not be played off of the game data store 350. However, in some embodiments, the secondary memory may be utilized as virtual memory, in which case portions of the game data store 350 may also serve as active memory. This illustrates that active memory is not necessarily defined by a particular hardware component, but is defined by the ability of the game resources to actively manipulate and access objects within the memory to execute the game.

The game manager 352 manages players' connections into active games and previews. In one embodiment, there are individual game managers for each game available through the game service. Taking a single game as an example, the game manager will drop players into requested games. The game manager 352 also manages active games. In one embodiment, a player may connect to a game through the game manager 352. In other words, the game manager 352 may act as a gatekeeper for communications and connections between individual game instances. When a player drops out of a game, an instruction may go to the game manager to retrieve and save the player's progress into the player's profile within player profile data store 344. Once a player drops out of a game, the game may be shut down by the game manager 352.

The game promotion manager 354 will preemptively download to a game client 310 blocks of game that may be used to generate a preview in combination with the preview file. The game blocks may be the first part of a full game or specially designed demos. Either way, the game promotion manager 354 may identify a player's likely game interest and select relevant games for download to the game client 310. Once downloaded, the user may be notified that the game preview may be played. The user may be given the option to purchase the game during game play, which may be a trigger event for migration. Once purchased, the remainder of the game may be downloaded and the user can be migrated to the full server version of the game while the download occurs, if needed.

Turning now to FIG. 4, a remote gaming environment 400 with preview capabilities is shown, in accordance with an embodiment of the present invention. Environment 400 includes game consoles 410, 412, and 414. The game consoles are connected to game service 430 via network 420. Game service 430 may be similar to game server 340 described previously with reference to FIG. 3. Similarly, the game consoles may be similar to the game consoles described previously with reference to FIGS. 2 and 3.

The game service 430 includes a preview-file data store 432. Four different preview files are shown for four different games. In one embodiment, each game title has its own preview file. The preview files include a game A preview file 433, a preview file for game B 434, a preview file for game C 436, and a preview file for game D 438. Though not shown, each game could have multiple preview files that are generated to match users fitting a particular profile. For example, a first preview file could limit play to a wizard avatar and a second preview file a princess warrior. The preview file that enables the character most likely to be of interest to the player may be used to generate the preview for the player. The player could also choose the preview scenario, but once chosen would be limited to the selected avatar.

The game service 430 also includes a preview manager 440, a game data store 442, and a game execution environment 446. The preview manager 440 may be similar to the preview manager 341 described previously and method 900 described subsequently. In brief, the preview manager 440 is responsible for managing the preview files and performing other tasks related to facilitating a preview experience for players. For example, the preview manager 440 may determine whether the preview should be generated by the server or the client.

The game data store 442 may be similar to the game data store 350 described previously with reference to FIG. 3. The game data store 442 stores copies of executable code for video game titles available on the game service 430. The video game code for individual titles may be accessed from the game data store 442 as game instances are executed within game execution environment 446. The game execution environment 446 may be similar to the game execution environment 348 described previously. The game execution environment 446 generates game previews that are run by the game service and streamed to the game client in certain circumstances.

To generate a game preview, the game execution environment 446 retrieves game code for the requested video game title from the game data store 442. In this case, video game code 452 for game C is shown being communicated from game data store 442 to game execution environment 446. The game code 452 is loaded into active memory where it can be executed and used to create a preview experience in combination with the preview file 450 that is communicated to the game execution environment 446. The preview file 450 is also for video game title C. As mentioned, the preview file 450 may be a decryption key that partially unlocks the video game code. Different aspects of the video game may be unlocked to create a preview experience. In general, less than the entire video game is unlocked. Alternatively, the video game is fully unlocked, but for a limited time, in which case the preview file may comprise a decryption key that expires after a designated time.

As mentioned, the preview may be provided in at least three different ways. Three different exemplary preview scenarios are illustrated with the game consoles shown. The preview manager 440 or the game preview component 347, explained previously, may select the scenario to implement.

In one embodiment, the preview runs on the game client. To run the game preview, the client needs access to the game code. Game console 410 is shown with the code 411 for game A. The game code 411 may be the entire game code needed to run a full version of game A. Alternatively, the code 411 may be a first chunk of the game code. The code 411 may have been downloaded in advance as part of a preview management program that preemptively downloads game code for games that may interest the player. Downloading the full game code allows the player to have immediate access to the game on the client should they purchase it.

When initially downloaded, the game code 411 may be encrypted and a decryption key is used for the player to experience the game on the game console 410. As can be seen, the preview file 450 is communicated to the game console 410. The preview file 450 may include a decryption code that is able to create the preview experience in combination with the game code 411. The preview file 450 makes less than the entire capabilities of the video game title available during the preview. Notice that a copy of the same preview file is used in both the client and server generated previews.

A second preview scenario is illustrated by game console 412. In the second scenario, the game preview is streamed as rendered image packets 460 to the game console 412. The rendered image packets 460 are generated in game execution environment 446. Though not shown, the control data from the game console 412 is communicated to the game service 430 where the game preview is running. Embodiments of the present invention stream a game preview when the network connection exceeds a threshold quality of service. The quality of service may be set at different points for different games. Several characteristics of the connection may be measured when determining QOS. Exemplary characteristics include dropped packet rates, jitter, bitrate, Wi-Fi signal strength, and latency. Different games have different levels of sensitivity to the QOS. Different games may have different QOS thresholds and use different QOS characteristics or combinations of QOS characteristics to define the threshold. For example, the quality of service threshold may be set so that the preview is only streamed when the connection adds less than an amount of latency that would noticeably degrade the preview experience. The latency threshold could be different for each game.

The third preview scenario, which is illustrated on game console 414, is downloading the game, or part of the game, to the game console 414 where it is executed in combination with a preview file 450. The preview file 450 may comprise a preview decryption key that acts as a partial decryption key. Upon purchasing the video game, a full decryption key is used to unlock the same game code for full game play.

The preview manager 440 may also facilitate updating the preview files. A developer or other authorized entity may change the preview scenarios as needed by updating the preview files to improve preview performance. For example, if players are not buying the game after playing the preview, then it may be updated.

The preview files may provide many different preview scenarios. In one embodiment, the preview scenario is time based. For example, the decryption key may only work for two hours, eight hours, twenty-four hours, or some other time period after which the preview is no longer available to the user. In this scenario, all other game features may be available to the user while the time-based preview is ongoing.

Another preview scenario limits the players to certain levels. For each level, all other game features normally available on the level may be available to the user. Embodiments of the present invention define the term “level” as a game environment. Level may apply to a particular level in a game that has “levels.” but could also apply to a map, track, field, city, or other scenario that limits access to just part of the game.

In another embodiment, the avatar-limited preview is provided. This allows the player to play the game from the perspective of a limited number of avatars. In one embodiment, the avatar that a user can play is selected specifically for the particular user's perceived interests. In an alternative embodiment, the player is able to choose which avatar is decrypted, but is bound to the choice during the preview. In yet another alternative, the player may switch avatars a limited number of times but does not have free access to all of the avatars available during the full game. Within embodiments of the present invention, an avatar could be a character, team, car, or ship that is controlled by the user during game play.

In one embodiment, the preview experience is adversary-based. An adversary-based preview experience allows the user to play against a limited number of characters, teams, character class, cars, ships, or other adversaries that are not controlled by the user during the game, but that the avatar controlled by the user interacts with.

The mission-based preview experience allows the user to complete only certain missions within the world. Within the mission, the user may have access to all avatars and items that are associated with the mission and compete against all adversaries associated with the mission.

In another embodiment, the preview scenario is turn-based. A turn-base scenario may be worthwhile in turn-base games and allows the user to play for X number of turns. As part of updating the preview, the number of turns could be modified to adjust the preview experience.

In another embodiment, the preview experience is game-based. This allows the player to play X number of games before the preview experience is terminated. A game may end when the player dies and has to start over. This would allow the player to effectively have a certain number of lives within the game. For some games, it may be possible to complete the game during the preview, but the goal is to get a higher score and the user may only be allowed to play the game X number of times as determined by the preview-parameter file. For example, the user could play a card game a designated number of times before being forced to purchase the game if they wish to continue playing.

The game-type based scenario limits the number of players that can play during the preview. For example, during a preview, the game type could be limited to a single player whereas a full version of the game may accommodate multiplayer scenarios. The opposite could also be true; embodiments could limit the preview to multi-player play where single-player would also be available during the full version of the game.

Another preview scenario is the item-based scenario. The item-based preview allows only access to certain items. Exemplary items could be weapons, medicines, communication devices, armor, tires, or other game items.

The input-based preview allows use of only a limited number of controller types. For example, the preview scenario could be limited to a game pad whereas the full version of the game could also utilize a video camera or other input.

Other game preview scenarios are possible, including mixing and matching various scenarios listed above. For example, a preview scenario could be avatar-based, item-based, and mission-based. This preview scenario would limit the use of a subset of avatars for a particular mission while using only certain items. Other combinations of the various preview scenarios described previously are possible. For example, almost all of the preview scenarios could also be time-based in addition to be limited to an avatar, item, mission, or something else.

### Game Migration

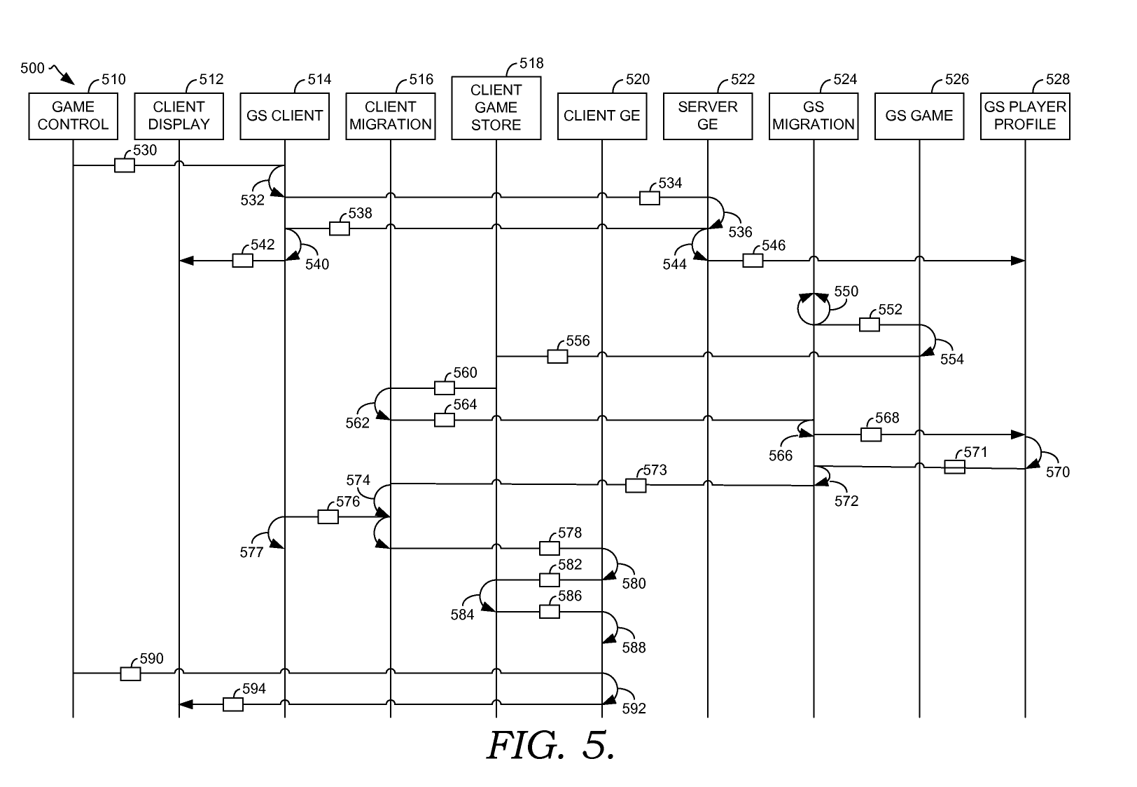

Turning now to FIG. 5, a sequence diagram showing communications within a gaming environment 500 that facilitate the migration of game play from a gaming server to a gaming client is shown, in accordance with an embodiment of the present invention. A game preview generated initially on the client may migrate to the game service or vice versa. Similarly, a game preview that starts on the game service may be migrated seamlessly to the game client. In addition, purchasing the game during or after a preview may be a trigger to migrate play between devices.

The gaming environment 500 includes components operating on a gaming client, perhaps similar to game client 310, as well as components operating on a game server that could be similar to game server 340.

The components located on the game client include a game controller 510, a client display 512, a game service client application 514, a client migration component 516, a client game store 518, and a client gaming environment 520. Components located in the gaming service include game service gaming environment 522, game service migration component 524, game service data store 526, and game service player profile data store 528. Both the client and the gaming service may include additional components that are not shown in FIG. 5 for the sake of simplicity.

Initially, control input 530 from the game controller 510 is communicated to the game service client application 514 running on the client device. Exemplary control input includes voice input, joystick movement, button selection, touchscreen data, gyroscopic data, accelerometer data, video images, and three-dimensional depth cloud data. The control input 530 may be preprocessed 532 into a form usable by the game service gaming environment 522 running on the game service server. The preprocessing is not required in some embodiments in which case the raw input signal may be communicated. The preprocessed control input 534 is communicated from the game service client application 514 to the game service gaming environment 522 where it is used to manipulate 536 game objects. A new game image 538 is rendered in response to the control input 534 and communicated to the game service client application 514. The rendered game image 538 is scaled 540 to a size appropriate for the client display 512, if needed. The scaled video image 542 is communicated to the client display 512 for display to the user. The scaled video image 542 may include audio data as well.

Game state information 546 is generated 544 and then communicated to the gaming-service player profile data store 528. The game state is periodically saved so that a user may return to a point in the game. Other components may also monitor game state information for triggering events.

A download trigger, which is distinct from a migration trigger, is detected at step 550. The download trigger may be a user decision to purchase the rest of the game being played in the ongoing gaming session. For example, the user may start out playing a first block of the game that was downloaded as part of a promotion or demo. In another embodiment, the user has previously purchased the game but did not have available bandwidth to download the next block of the game. The download event 550 could be detecting the change in the user's bandwidth or bandwidth usage to provide download availability. Another trigger is use of a different device. For example, the user could purchase the game using a light client or other device that is not capable of rendering or running the game locally or does not have local memory available to store the game. When the use logs into the game service from a client that is capable of running the game locally, then the game may be downloaded.

A download request or instruction 552 is communicated from the game service migration component 524 to the game data store 526. The game data store prepares 554 the next block of the game to be downloaded and downloads the game block 556 to the client game store 518. The client game store 518 saves 558 the game block 556. Though depicted as a single message, the game block 556 and other messages shown in the sequence diagram may actually be a series of messages that occur over time. For example, in some situations, it may take twenty or thirty minutes to download the game block 556 to the client game store 518 depending on the available bandwidth in the user's connection. Once saved, a notification 560 is sent to the client migration component 516 indicating that the game block is ready for use. At step 562, a download completion message 564 is generated and communicated to the game service migration component 524.

At step 566, a game-migration trigger is detected. In this case, the complete downloading of a game block to the client device constitutes the triggering event. Upon detecting the trigger 566, information needed for the migration is gathered. In this case, the request for game state information 568 is generated and communicated to the gaming service's player profile data store 528. The game state is retrieved 570 and a game-state message 571, which describes current player progress and other game parameters is communicated to the client migration component 516. Using the game state information, a games migration message 573 is generated 572 and communicated the client migration component 516 or other component on the client device. The game migration message provides the client device the information needed to start game play on the client where it left of on the server.

Upon receiving the state information and migration instruction, the client migration component 516 begins the game migration process from the client side at step 574. A message 576 terminating activity on the game service client application 514, which had previously been receiving the rendered video game image is communicated. The termination may not be immediate. Once the client gaming environment 520 has the ongoing game loaded into active memory and is ready to take over, the game service client application 514 is terminated 577. Terminated may indicate that the gaming service application is closed or just minimized. Either way, the game service client application 514 is not actively involved in processing or displaying information received from the game server once it is terminated.

An activation message 578 is also sent to the client side gaming environment 520. Game activation 580 begins in response to the activation message 578. As part of the activation 580, the client gaming environment 520 requests 582 the game code from the client game store 518. The game code is prepared 584 and communicated 586 back to the client gaming environment 520. The gaming data is then loaded 588 into active memory and prepared for game play. The game state information received previously is used to set the game at a point where the user requested it. In one embodiment, the gaming environment 520 has the game activated and ready for play while game play continues on a gaming server and rendered images are displayed through the game service client application 514. Upon reaching a transitional point in the game, such as switching levels, the game play is transitioned from the game service client application 514 to the client gaming environment 520.

Once transitioned, game control data 590 is communicated to the client gaming environment 520 where game objects are manipulated 592 and a new video game image is rendered. The new video game image 594 is communicated to the client display 512 where it is displayed to the user.

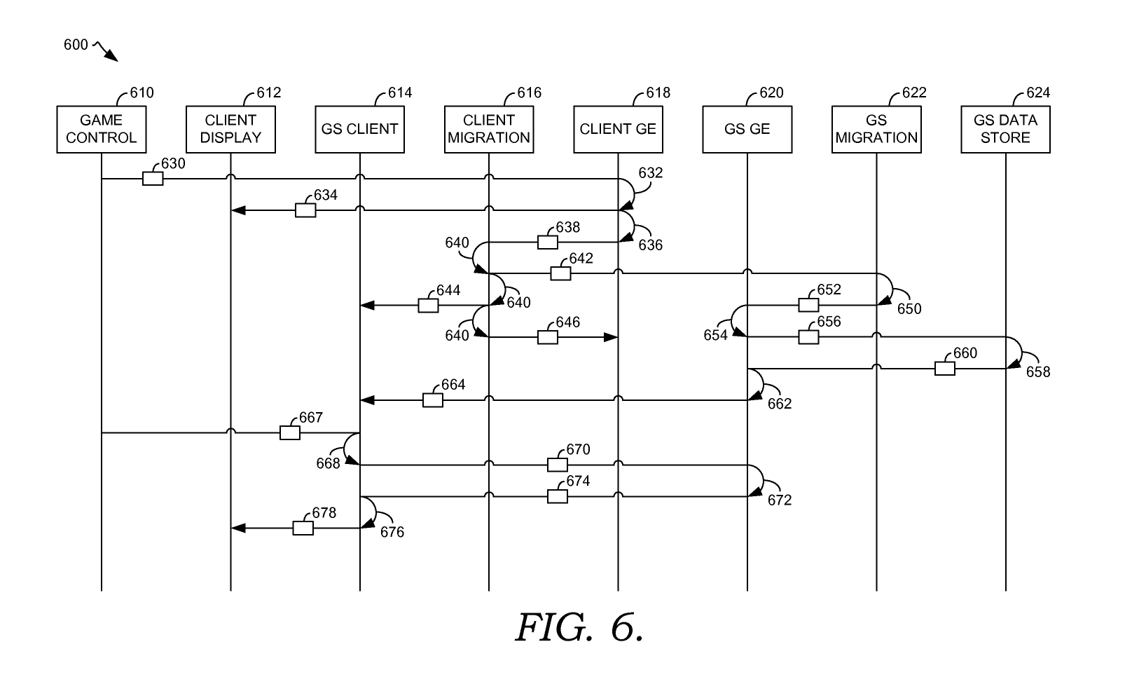

Turning now to FIG. 6, a sequence diagram showing communications occurring within a gaming environment 600 during migration of a game from a client gaming device to a server located gaming service is shown, in accordance with an embodiment of the present invention. The gaming environment 600 includes components operating on a gaming client, perhaps similar to game client 310, as well as components operating on a game server that could be similar to game server 340. The components located on the game client include a game controller 610, a client display 612, a game service client application 314, a client migration component 616, and a client gaming environment 618. Components located in the gaming service include game service gaming environment 620, game service migration component 622, and game service data store 624. Both the client and the gaming service may include additional components that are not shown in FIG. 6 for the sake of simplicity.

Initially, the user is playing a game that is running within the client's gaming environment 618. The gaming signals 630 are communicated from game controller 610 to the client gaming environment 618 where the game objects are manipulated in response to the signals 630 and the video game is rendered 632. The rendered video game image 634 is communicated to the display device 612 where it is displayed to the user.

At step 636, the client gaming environment 618 communicates a game state update message 638 to the client migration component 616. The game state update message 638 may describe the user's current progress within a game as well as other instructions or requests made by the user. For example, the user could have entered a menu request for a new level. In other example, the user selects an avatar or team that is not available for local play.

At step 640, the client migration component 616 analyzes the game state message 638 and determines that a triggering event has occurred. For example, the user may have requested a new level or reached a point in the game where a new level that has not yet been downloaded to the game client is accessed. At this point, the client migration component 616 generates a series of communications to start the migration process.

Upon detecting the trigger, the client migration component 616 communicates a migration request 642 to the game service migration component 622. This may first necessitate opening a communication session with the game service if one is not already active. The process of opening a communication session is not shown in FIG. 6 nor is the authentication process or other processes that may be required for the gaming service to accept the game migration request.

The game service migration component 622 analyzes the migration request at 642 at step 650. The request may be analyzed for resource availability. For example, the game service migration component 622 may query available resources to determine if an instance of the game at a particular level is available or can be made available to the user. The game service migration component may also query other components to make sure that the user has appropriate access for the requested game level. Though not shown, the game service migration component 622 may query the client side migration component 616 for additional information if needed.

Turning back to the game communications issued by the client migration component 616 upon detecting a triggering event, at step 640, the client migration component 616 may send an activation request 644 to the game service client application 614. The activation request 644 causes the game service client application 614 to open and to prepare for receiving a rendered video game. In addition, the client migration component 616 sends a termination message 646 to the client gaming environment 618 that instructs termination of the game execution, pending migration to the gaming service server.

In response to receiving the migration request 642, the game service migration component 622 communicates an activation message 652 to the game service gaming environment 620. In response to the activation message 652, the game service gaming environment 620 activates an instance of the requested game at a point in the game requested by the user. The game service gaming environment 620 may receive player profile and game state information within the activation message 652. This information may have been communicated in the migration request 642 or through a separate message not shown in the sequence diagram of FIG. 6.

As part of the activation 654, the game service gaming environment 620 may send a game data request 656 to the game data store 624. In response, a game data package is prepared 658 and communicated 660 to the game service gaming environment 620. At step 662, the game service gaming environment 620 loads the game data into active memory and prepares to receive I/O connection and data from the game service client application 614 or other components associated with the game client.

Once activated, the game service gaming environment 620 sends a rendered image of the video game to the game service client application 614. The rendered image is shown as message 664. Upon receipt, the game service client application 614 may communicate the image to the client display 612. Audio may also be communicated as part of the video. Throughout this application, when image data for a video game is generated then audio data may also be generated and included in any communication.

Game control data received from game controller 610 is communicated to the game service client application 614. The control data 667 s preprocessed at step 668 to an easily uploadable format that will be processed by game service gaming environment 620. The preprocessed game controls 670 are communicated to the game service environment 620. The game objects are manipulated in response to the controls 670 at step 672. A new rendered game image 674 is then communicated back to game service client application 614 where it may be scaled for the client display 612 at step 676. Once appropriately scaled, the rendered image is communicated 678 to the client display 612 where it appears to the user.

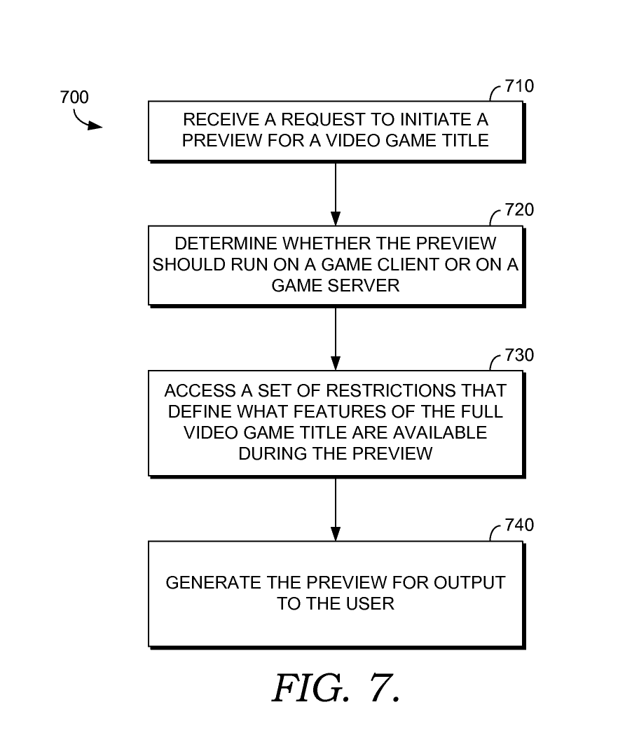

Turning now to FIG. 7, a method 700 of providing a video game preview is shown, in accordance with an embodiment of the present invention. At step 710, a request to initiate a preview for a game title is received. The request may be received by a game service or by the game client. Either the game service or the game client will determine, at step 720, whether the preview should run on a game client or on the game server. As part of determining step 720, game code to run the preview is sought on the game client. If the game code is present or available locally, then the preview will run on the game client. If the game code is not available on the client, then a determination will be made whether the game preview should be generated by the game service and streamed to the game client.

The quality of service (“QOS”) for the connection between the game service and client is evaluated to determine whether the game preview should be streamed to the game client. When the QOS is above a threshold for the requested game title, then the game preview is generated on the game service and streamed to the game client. If the QOS is below the threshold, the code needed to run the video game preview is communicated from the game service to the game client.

At step 730, a set of restrictions that define what features of the full video game title are available during the preview are accessed. The set of restrictions may be stored on a central game server. In another embodiment, the restrictions are embedded in the game code itself. All game clients wishing to run the preview may access a copy of the restrictions. Similarly, the restrictions may be accessed by the game service when the game service generates the preview and streams it to the user.

If the preview is running on the client, the restrictions may first be communicated to the game server. The set of restrictions may take the form of a decryption key that decrypts less than the full game features. The actual game code used to generate the preview may be a full version of the game code that is capable of generating a full-featured game experience. When the preview is generated by the game service, the set of restrictions may be accessed by retrieving them from a preview file storage. In another embodiment, the set of restrictions is not a decryption key, but rather explain what features of the full game should be available within the preview experience.

At step 740, a preview that allows the user to experience the full video game title as limited by the set of restrictions is generated for output to the user. As mentioned previously, the preview may be generated by running part of the full game code that is decrypted to generate a preview. The preview may be generated on either the game client or the game server, as determined previously at step 720.

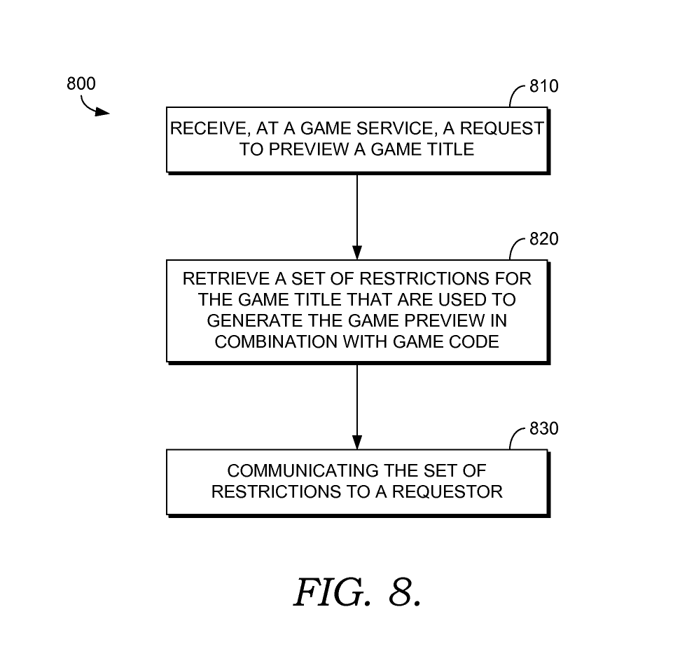

Turning now to FIG. 8, a method 800 of providing a video game preview is shown, in accordance with an embodiment of the present invention. At step 810, a request to preview the game title is received at a game service. At step 820, a set of restrictions for the game title that are used to generate the game preview in combination with game code are retrieved. In one embodiment, a single game title may be associated with different sets of restrictions to generate different scenarios. For example, a player's game preferences may be used to select a preview that is tailored to the player's preferences. The preview may be tailored by altering the set of restrictions.

At step 830, the set of restrictions are communicated to a requestor. The requestor may be a game client, or execution environment on the game service that is preparing to generate a preview. As mentioned previously, the restrictions can create a game preview that is limited in one of several ways. For example, the set of restrictions may limit the avatars, levels, items, play time, duration of play, and other features of the game. The various ways to limit the full game from functionality may be combined within a set of restrictions to create a unique preview experience.

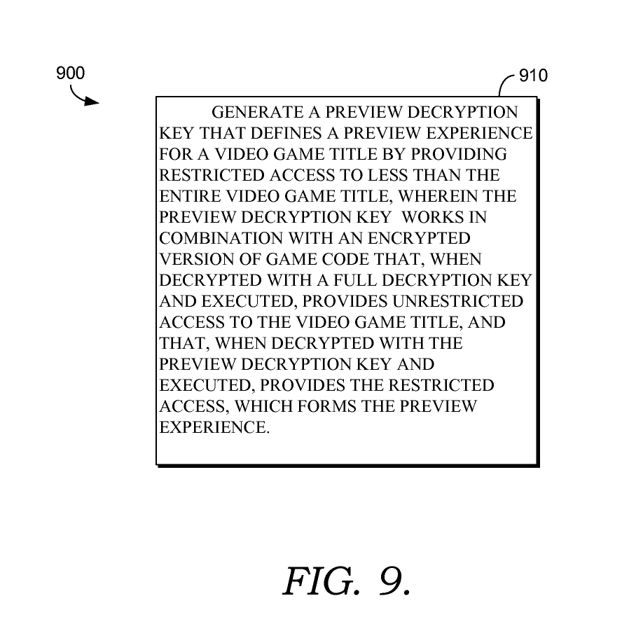

Turning now to FIG. 9, a method 900 of providing a video game preview is shown, in accordance with an embodiment of the present invention. At step 910, a preview preview decryption key is generated. The preview decryption key defines a preview experience for a video game title by providing restricted access to less than the entire video game title. The access may be restricted by using a preview decryption key that only decrypts part of the game's features. The game code, when decrypted with a full decryption key and executed, provides unrestricted access to the video game title. When decrypted with the preview decryption key and executed, the code provides restricted access to the game, which forms the preview experience.

Once generated, the preview decryption key may be modified to improve the preview experience. Multiple preview decryption keys may be generated for an individual title. The preview decryption key may be communicated to the requesting client device in real time as the client device begins to generate a preview experience. The preview decryption key may be deleted from the client upon termination of the preview experience. If the user wishes to restart the preview of the same title then a new preview decryption key may need to be communicated to the client.

The use of preview decryption keys may be tracked on a per user basis. The number of times the user is allowed to experience a preview of a particular game may be limited. In addition, a user's game interests may be ascertained by evaluating the user's preview activity. The user's interests may be utilized to create a game profile for the user. The game profile may be used to display advertisements for games or to suggest additional game previews. Total interest in previews from all users may also be tracked.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon that when executed by a computing device perform a method of providing a video game preview, the method comprising:
receiving a request to initiate a preview for a video game title;
determining whether the preview is generated on a game client or on a game server;
accessing a set of restrictions that define what features of a full video game title are available during the preview; and
generating, for output to a user, the preview by running game code for the full featured video game as limited by the set of restrictions.

2. The media of claim 1, wherein the method further comprises determining whether code needed to generate the preview is available on the game client.

3. The media of claim 2, wherein the method further comprises, upon determining the code needed to generate the preview is not available on the game client, determining whether a network connection between the game client and the game server is above a minimum quality of service.

4. The media of claim 3, wherein the method further comprises upon determining the network connection between the game client and the game server is above the minimum quality of service, running the preview on the game server and streaming the preview to the game client.

5. The media of claim 3, wherein the method further comprises upon determining the network connection between the game client and the game server is not above the minimum quality of service, downloading the code to the game client.

6. The media of claim 1, wherein the set of restrictions are stored on the game server.

7. One or more computer-storage media having computer-executable instructions embodied thereon that when executed by a computing device perform a method of providing a video game preview, the method comprising:
receiving, at a game service, a request to preview a game title;
retrieving a set of restrictions for the game title that are used to generate a game preview in combination with game code for the game title; and
communicating the set of restrictions to a requestor.

8. The media of claim 7, wherein the request is received from a game client and the set of restrictions are stored by the game service.

9. The media of claim 8, wherein the method further comprises receiving instructions to update the set of restrictions for the game preview and updating the set of restrictions according to the instructions.

10. The media of claim 7, wherein the game code is operable to generate a full version of the game title and the set of restrictions comprise a decryption key that decrypts less than all features of the full version of the game title.

11. The media of claim 7, wherein the method further comprises saving game state information that reflects player progress during the preview.

12. The media of claim 11, upon determining that a full version of the game title is purchased by a user receiving the preview, applying the player progress to the full version of the game title.

13. The media of claim 7, wherein the set of restrictions are adversary based and restricts the preview to a limited set of adversaries.

14. The media of claim 7, wherein the set of restrictions are item based and restricts the preview to a limited set of game items.

15. A method of providing a video game preview, the method comprising:
generating a preview decryption key that defines a preview experience for a video game title by providing restricted access to less than a full video game title,
wherein the preview decryption key decrypts only part of an encrypted version of the game code that, when decrypted with a full decryption key and executed, provides unrestricted access to all features of the video game title.

16. The method of claim 15, further comprising:
communicating the preview decryption key to a game client.

17. The method of claim 15, further comprising:
communicating the preview experience to a game client, the preview experience being generated by a game service using the preview decryption key to run a partially decrypted version of game code.

18. The method of claim 15, wherein the method further comprises:
determining that a game client does not have local access to the encrypted version of game code and that a network connection between the game client and the game service falls below a threshold quality of service standard; and
communicating the encrypted version of game code and the preview decryption key to the game client.

19. The method of claim 18, wherein the method further comprises, receiving a request from the game client to purchase the video game title and communicating the full decryption key to the game client.

20. The method of claim 15, wherein the method further comprises updating the preview decryption key to generate a different preview experience.
